(19) United States
(12) Patent Application Publication
(10) Pub. No.: US 2019/0294780 A1
(43) Pub. Date: Sep. 26, 2019

(54) SYSTEM AND METHOD FOR EXECUTING OPERATING SYSTEM LEVEL VIRTUALIZATION SOFTWARE OBJECTS

(71) Applicant: International Business Machines Corporation, Armonk, NY (US)

(72) Inventors: Roie Melamed, Haifa (IL); Alexey Roytman, Givat Elah (IL); Aidan Shribman, Ganei Tikva (IL)

(21) Appl. No.: 15/935,072

(22) Filed: Mar. 26, 2018

(51) Int. Cl. G06F 21/53; G06F 21/62

(52) U.S. Cl. CPC G06F 21/53; G06F 2221/2149; G06F 21/6245

(57) ABSTRACT

A system for executing one or more operating-system-level virtualization software objects (virtualization containers), comprising: at least one hardware processor connected to at least one data communication network interface, and adapted to: for each of the one or more containers: execute the container in at least one isolated process of an operating system, wherein the container is created from one or more software image files comprising a plurality of data patterns, each data pattern comprising at least one output target and an access instruction; and while executing the container: identify at least one forbidden input-output (I/O) instruction of the virtualization container, by matching an instruction target of at least one of a plurality of I/O instructions of the virtualization container with at least one output target of at least one data pattern of the plurality of data patterns; and decline execution of the forbidden I/O instruction(s).

### BACKGROUND

The present invention, in some embodiments thereof, relates to a system for executing operating system level virtualization objects and, more specifically, but not exclusively, to a data management system comprising operating system level virtualization objects.

There exist reasons to limit access to sensitive electronic information. Some examples of sensitive electronic information are a person's name, a person's address, an identification number such as a passport number, a Social Security number or a national identification number, a bank account identifier, and a health record. Some reasons to limit access to the sensitive electronic information are business related, for example to protect business interests of a business entity. Some other reasons are regulatory, for example regulations governing distribution of and access to health information. An example of a regulation regarding health information is United States Health Insurance Portability and Accountability Act of 1996 (HIPAA). An example of a regulation regarding sensitive electronic information is European Union (EU) General Data Protection Regulation (GDPR).

Some existing systems control access to sensitive electronic information by isolating the system from other systems. In such systems the sensitive electronic information is stored in dedicated storage devices, and processed by dedicated hardware processors. Some such systems comprise a central database, implementing access control lists to restrict access to data stored in the database. In some such systems only explicitly authorized computers, identified by a network address or a network device port, may retrieve the sensitive electronic information.

The term “cloud computing” refers to delivering one or more hosted services, often over the Internet. Some hosted services provide infrastructure. Examples of a hosted service providing infrastructure delivered over the Internet are a compute resource such as a physical machine, a virtual machine (VM) or a virtual environment (VE) on which an application workload may execute, storage and networking. Cloud computing enables an entity such as a company to consume the one or more hosted services as a utility, in a pay-as-you-go model shifting the traditional capital expense (CAPEX) and operational expense (OPEX) cost structure to a pure OPEX cost structure. With the operational flexibility this model may offer, there is an increase in the amount of systems implemented using cloud computing for data storage and data management applications. Possible advantages of a cloud implementation of a data management system compared to a system comprising dedicated storage devices and dedicated hardware processing resources include reduced cost of storage and computing resources, simpler storage management, easier expansion and shrinking of the data management system, better backup and recovery, and decreased Information Technology (IT) maintenance costs.

Cloud computing helps reducing costs by sharing one or more pools of discrete resources between one or more customers (typically referred to as “tenants”) of a cloud computing service. In some cloud computing service implementations some resources of the one or more pools of discrete resources are assigned to a tenant for the tenant's exclusive use. In some cloud computing service implementations the one or more pools of discrete resources are shared by one or more tenants, each running one or more software application workloads, with the cloud computing service providing isolation between the one or more tenants. When sharing a discrete resource amongst one or more tenants, full isolation between the tenants is paramount.

One possible means of isolating between the one or more software applications is by using virtual machines (VMs). VMs are created on top of a hypervisor, which is installed on a host operating system. Another possible means of isolating between the one or more software applications is by using operating-system-level virtualization software objects, where an operating system kernel allows the existence of multiple isolated user-space instances for running the one or more software applications. Each of these isolated user-space instances is an operating-system-level virtualization software object, also known as a container or a virtualization container, each running one or more software programs or applications in isolation from other software programs. A container directly runs on a host operating system (OS) or on a container platform engine running directly on the host OS. In some implementations, the container does not execute a guest OS of its own. A program running inside a container can only see the container's contents and devices assigned to the container. The host OS provides isolation and does resource allocation to each of the individual containers running on the host OS. Examples of container technologies are Docker, FreeBSD jails, and CoreOS Rocket. Another example of container technologies is any technology compliant with the Open Container Initiative (OCI).

A system using cloud computing may be susceptible to any of a plurality of security risks, some of which may cause data to leak from the system to an unauthorized target. Some security risks are unintentional; some others are a result of a malicious attack.

### SUMMARY

It is an object of the present invention to provide a system and a method for executing operating system level virtualization objects.

The foregoing and other objects are achieved by the features of the independent claims. Further implementation forms are apparent from the dependent claims, the description and the figures.

According to a first aspect of the invention, a system for executing one or more operating-system-level virtualization software objects (virtualization containers) comprises: at least one hardware processor connected to at least one data communication network interface, and adapted to: for each of the one or more virtualization containers: execute the virtualization container in at least one isolated process of an operating system, wherein the virtualization container is created from one or more software image files comprising a plurality of data patterns, each data pattern comprising at least one output target and an access instruction; and while executing the virtualization container: identify at least one forbidden input-output (I/O) instruction of the virtualization container, by matching an instruction target of at least one of a plurality of I/O instructions of the virtualization container with at least one output target of at least one data pattern of the plurality of data patterns; and decline execution of the at least one forbidden I/O instruction.

According to a second aspect of the invention, a method for executing one or more virtualization containers comprises for each of the one or more virtualization containers: executing the virtualization container in at least one isolated process of an operating system executed by at least one hardware processor, wherein the virtualization container is created from one or more software image files comprising a plurality of data patterns, each data pattern comprising at least one output target and an access instruction; and while executing the virtualization container: identify at least one forbidden input-output (I/O) instruction of the virtualization container, wherein the I/O instruction is forbidden according to the plurality of data patterns; and decline execution of the forbidden at least one I/O instruction. Declining execution of a forbidden I/O instruction may facilitate isolating one or more software programs running in a virtualization container from other software programs running on the at least one hardware processor, and may help prevent sending data to an unauthorized output target.

According to a third aspect of the invention, a computer implemented method for producing one or more software image files for creating a virtualization container comprises: receiving one or more virtualization container definition files describing the virtualization container; receiving a plurality of access rules governing input to and output from the virtualization container, each comprising at least one first output target and a first access instruction; producing a plurality of access patterns equivalent to the plurality of access rules, each comprising at least one second output target and a second access instruction; and producing one or more software image files comprising the plurality of access patterns and digital information for creating the virtualization container.

With reference to the first and second aspects, in a first possible implementation of the first and second aspects of the present invention, the at least one hardware processor is adapted to identify at least one forbidden I/O instruction by: identifying at least one I/O instruction of the plurality of I/O instructions of the virtualization container, wherein executing the at least one I/O instruction results in the at least one hardware processor receiving or sending digital data via the at least one data communication network interface; comparing the instruction target of the at least one I/O instruction to a plurality of output targets of the plurality of data patterns to identify at least one data pattern having at least one output target matching the instruction target according to a target matching test, and having an access instruction forbidding access to the at least one output target; and identifying the at least one I/O instruction as forbidden subject to identifying the at least one data pattern. Using a plurality of data patterns and comparing an instruction target to one or more output targets of the plurality of data patterns, may facilitate identifying more than one forbidden I/O instructions.

With reference to the first and second aspects, or the first implementation of the first and second aspects, in a second possible implementation of the first and second aspects of the present invention, when creating the virtualization container the at least one hardware processor is adapted to modify a plurality of computer instructions of at least one network system call of the virtualization container to: compare at least one parameter of the at least one network system call to one or more output targets of the plurality of data patterns; identify a match between the at least one parameter and at least one output target according to the target matching test; identify at least one data pattern having the at least one output target and an access instruction forbidding access to the at least one output target; and decline execution of at least one output instruction of the at least one network system call subject to identifying the at least one data pattern. Executing the at least one modified network system call identifies the at least one I/O instruction of the virtualization container. The at least one hardware processor is adapted to compare the instruction target of the at least one I/O instruction to a plurality of output targets of the plurality of data patterns, identify the at least one data pattern and decline execution of the at least one forbidden I/O instruction by executing the modified plurality of instructions of the at least one network system call. Modifying a plurality of computer instructions of at least one network system call of the virtualization container may provide a means for identifying, while executing a virtualization container, an attempt to execute a forbidden I/O instruction and to decline executing the forbidden I/O instruction.

With reference to the first and second aspects, or the first implementation of the first and second aspects, in a third possible implementation of the first and second aspects of the present invention, the at least one hardware processor is adapted to execute Security-Enhanced Linux (SELinux), wherein SELinux has a policy. Executing the virtualization container comprises for at least one data pattern of the plurality of data patterns: generating a rule comprising the access instruction of the at least one data pattern; generating at least one label mapping the at least one output target of the at least one data pattern to the rule; and configuring the SELinux policy with the rule and the at least one label. The at least one hardware processor is adapted to identify the at least one I/O instruction of the virtualization container, comparing the instruction target of the at least one I/O instruction to a plurality of output targets of the plurality of data patterns, identify the at least one data pattern and decline execution of the at least one forbidden I/O instruction by executing a SELinux method as known in the art for enforcing Mandatory Access Control using the SELinux policy configured with the rule and the at least one label.

With reference to the first and second aspects, in a fourth possible implementation of the first and second aspects of the present invention, the at least one output target is a member of a group consisting of: a network address value, a network address template value comprising at least one variable network address element, and a network port value. A network address template value may be used to identify a range of network addresses. Optionally, at least one access instruction is a member of a group consisting of: permission to listen to a network port, denial of permission to listen to a network port, permission to receive, denial of permission to receive, permission to send, and denial of permission to send. Access instructions may be permissive or restrictive, and combined with one or more output targets identifying one or more ranges of network addresses may provide flexibility in defining a complex security policy.

With reference to the first and second aspects, in a fifth possible implementation of the first and second aspects of the present invention, the at least one hardware processor is adapted to execute the virtualization container by a container platform engine. Some virtualization technologies execute one or more virtualization containers by a container platform engine.

With reference to the first and second aspects, in a sixth possible implementation of the first and second aspects of the present invention, the plurality of data patterns comprises at least one data pattern defined according to Health Insurance Portability and Accountability Act of 1996 (HIPAA) security regulations. Optionally, the plurality of data patterns comprises at least one data pattern defined according to European Union (EU) General Data Protection Regulation (GDPR). Defining some of the plurality of data patterns according to a security policy defined by a regulation authority may allow a data management system to operate in compliance with one or more regulations.

With reference to the third aspect, in a first possible implementation of the third aspect of the present invention, the one or more software image files are Docker image files modified to comprise the plurality of access patterns.

With reference to the third aspect, in a second possible implementation of the third aspect of the present invention, the plurality of access rules are received via a data communication network interface connected to at least one hardware processor executing the method or by reading the plurality of data patterns from a digital storage connected to the at least one hardware processor. Receiving the plurality of access rules via the data communication network interface may allow updating the plurality of access rules over time. Reading the plurality of data patterns from a digital storage may facilitate faster retrieval of the plurality of access rules than retrieving over a digital communication network.

With reference to the third aspect, in a third possible implementation of the third aspect of the present invention, the method further comprises storing the one or more software image files on a digital storage connected to at least one hardware processor executing the method. Storing the one or more software image files on a digital storage may allow future use of the software image files. Optionally, the method further comprises sending the one or more software image files via a digital communication network interface connected to at least one hardware processor executing the method. Sending the one or more software image files via a digital communication network interface may allow distributing the one or more software images to one or more destination systems, and in addition or alternately storing the one or more software image files in a remote repository.

With reference to the third aspect, in a fourth possible implementation of the third aspect of the present invention, the plurality of access rules comprises at least one access rule defined according to Health Insurance Portability and Accountability Act of 1996 (HIPAA) security regulations. Optionally, the plurality of access rules comprises at least one access rule defined according to European Union (EU) General Data Protection Regulation (GDPR). Defining some of the plurality of access rules according to a security policy defined by a regulation authority may allow a virtualization container created from the one or more software image files to be executed in a system that is required to comply with one or more regulations. Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram of an exemplary system for executing one or more virtualization containers, according to some embodiments of the present invention;

FIG. 2 is a flow chart schematically representing an optional flow of operations for executing a virtualization container, according to some embodiments of the present invention;

FIG. 3 is a flow chart schematically representing an optional flow of operations for identifying one or more forbidden input-output instructions, according to some embodiments of the present invention;

FIG. 4 is a flow chart schematically representing an optional flow of operations of a modified network system call, according to some embodiments of the present invention;

FIG. 5 is a flow chart schematically representing an optional flow of operations for configuring a SELinux based system, according to some embodiments of the present invention;

FIG. 6 is a schematic block diagram of an exemplary system for producing one or more software image files for creating a virtualization container, according to some embodiments of the present invention; and

FIG. 7 is a flow chart schematically representing an optional flow of operations for producing a one or more software image files for creating a virtualization container, according to some embodiments of the present invention.

### DETAILED DESCRIPTION

The present invention, in some embodiments thereof, relates to a system for executing operating system level virtualization objects and, more specifically, but not exclusively, to a data management system comprising operating system level virtualization objects.

For brevity, the terms “virtualization container” and “container” are used henceforth to mean “operating-system-level virtualization software object” and are used interchangeably.

When sensitive electronic information, for example electronically protected health information (ePHI), is stored and processed by a cloud implemented system, retrieval of sensitive electronic information from the cloud implemented system discloses the sensitive electronic information outside the boundaries of the cloud. This may be undesirable, for example for business considerations or regulatory and legal considerations. There exist solutions that monitor data at the data storage level, and allow a cloud implemented system to retrieve sensitive electronic information from storage only according to user authentication and predefined privileges. However, such systems cannot prevent the cloud implemented system from exposing the retrieved sensitive electronic information outside the cloud.

In some systems sensitive electronic information retrieved from the storage is encrypted, however some operations performed on the sensitive electronic information by the data management system require decrypting the sensitive electronic information, enabling the data management system to expose unencrypted sensitive electronic information. Systems that operate only on encrypted data are limited in functionality.

Some cloud implemented systems use virtualization containers. A program running inside a virtualization container can only see the container's contents and devices assigned to the container. However, in some existing container implementations, when multiple containers are executed on one physical node running a host operating system, all containers with access to a network device can send data to and receive data from any other container executing on the same physical node and having access to the network device. Thus, it is possible in such implementations for a program running inside a first container to send data to another program running inside a second container. In some cases, such an operation may be inserted maliciously into a program in order to exploit this network access vulnerability, for example by attacking a container running an outwards facing service. As container based implementations are increasingly used by systems, there is an increased need to identify such risks of exposing sensitive electronic information.

A container typically comprises one or more software programs or applications, and includes all dependencies, libraries, and other binaries, of the one or more software programs, and one or more configuration files needed to run the one or more software programs. In some container technologies, a virtualization container is created from one or more software image files comprising digital information for creating the container. Digital information for creating the virtualization container may include the one or more software programs, binaries such as dependencies of the one or more software programs and libraries used by the one or more software programs, and one or more configuration files needed to run the one or more software programs. A dependency may be an identified version of an application used by the one or more software programs. In such container technologies, executing a container comprises creating a dedicated container, that is a dedicated OS-level virtualization software object, according to the digital information in the one or more software image files, and executing the created container in at least one isolated process of the host OS. Optionally, the at least one isolated process is executed on a container engine running directly on the host OS.

The present invention, in some embodiments thereof, proposes adding to the one or more software image files access control information defining one or more permitted and/or forbidden flows of data to and from the one or more software programs running in a container created from the one or more software image files. Optionally, the access control information comprises a plurality of data patterns, each comprising at least one output target and an access instruction. Examples of an output target are a value of a network address, a template value of a network address comprising at least one variable network address element, and a network port value. A variable network address element may be a character representing a wildcard in a network address string value. Optionally, a network address template identifies a range of network addresses. In addition, in such embodiments, the present invention proposes identifying, while the container executes on at least one hardware processor, one or more input-output (I/O) instructions of the container that are forbidden according to the access control information and declining execution of the identified one or more forbidden I/O instructions. The access control information may be application specific, defined according to an identified plurality of requirements for the one or more software applications. Including the access control information in the one or more software image files allows coupling an access control policy with one or more software applications and may facilitate enforcing the access control policy on any host executing a container created from the one or more software image files. When the access control information is defined according to an identified plurality of requirements for the one or more software applications, including the access control information in the one or more software image files allows defining a first access control policy for a first container executed on a hardware processor, and a second access control policy different from the first access control policy for a second container executed on the hardware processor. In addition, identifying one or more forbidden I/O instructions while the container is executed may facilitate isolating the one or more software programs running in a first container from other software programs running on the at least one hardware processor, whether directly on the host OS or in one or more other containers, and may help prevent sending data to an unauthorized output target due to poor isolation between the one or more software programs and the other software programs.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

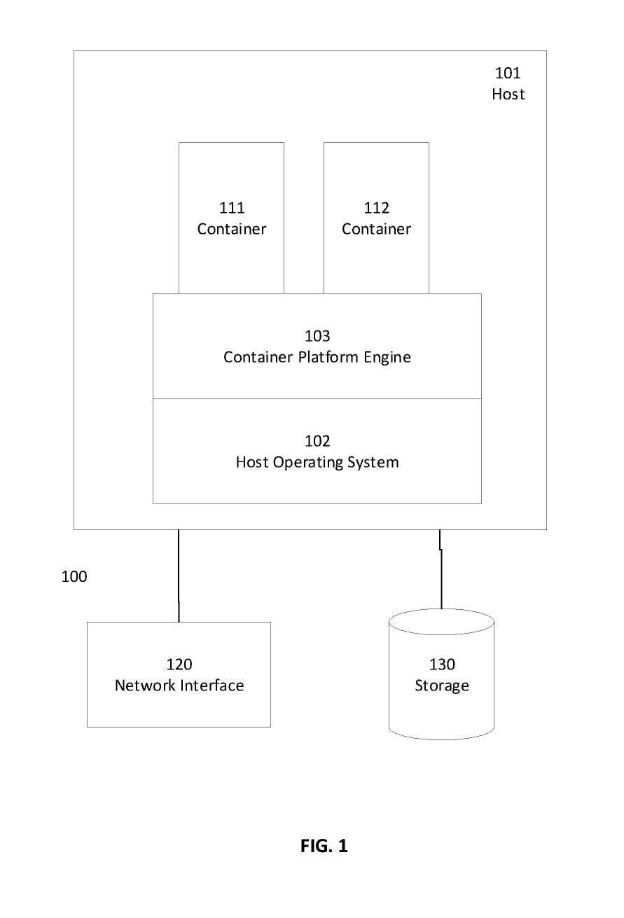

Reference is now made to FIG. 1, showing a schematic block diagram of an exemplary system 100 for executing one or more virtualization containers, according to some embodiments of the present invention. In such embodiments, at least one host processor 101 is connected to at least one data communication network interface 120 and executes host operating system 102. Examples of a host operating system are Linux distributions such as Ubuntu and RedHat, Ubuntu Core, Container Linux (CoreOS Linux), Apple macOS, Microsoft Server, and Microsoft Windows 10.

For brevity, the term “host processor” is used to mean “at least one host hardware processor”.

At least one data communication network interface 120 is optionally a Local Area Network interface such as an Ethernet network interface or a wireless network interface. Optionally host processor 101 is connected to a wide area network, for example the Internet, via at least one data communication network interface 120. Optionally, host processor 101 is connected to at least one storage 130, for example a hard disk.

Optionally, host processor 101 executes one or more virtualization containers 111 and 112. One or more virtualization containers may be executed directly by host operating system 102. Optionally, host processor 101 executes at least one container platform engine 103 and optionally executes one or more virtualization containers 111 and 112 by at least one container platform engine 103. Examples of a container platform engine are Docker daemon and CoreOS rkt.

To execute one or more virtualization containers such that one or more software applications running in one of the one or more virtualization containers does not violate one or more flow permission, system 100 implements, in some embodiments of the present invention, the following optional method.

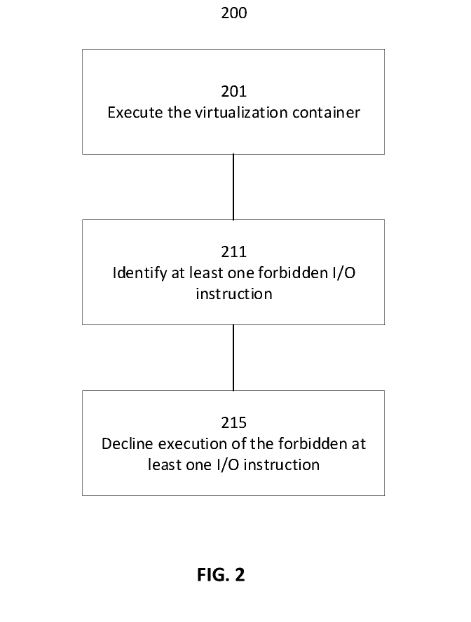

Reference is now made also to FIG. 2, showing a flow chart 200 schematically representing an optional flow of operations for executing a virtualization container, according to some embodiments of the present invention. In such embodiments, host processor 101 executes one or more virtualization containers 111 and 112. For each virtualization container of the one or more virtualization containers, for example virtualization container 111, in 201 host processor 101 optionally executes the virtualization container in at least one isolated process of host operating system 102. Optionally, virtualization container 111 is created by host processor 101 from one or more software image files comprising a plurality of data patterns. Optionally, the one or more software image files are Docker image files modified to comprise the plurality of data patterns. The plurality of data patterns optionally define one or more permitted and/or forbidden flows of data to and from the one or more software programs running in virtualization container 111 created from the one or more software image files. Optionally, each pattern comprises at least one output target and an access instruction. Examples of an output target are a value of a network address, a template value of a network address comprising at least one variable network address element, and a network port value. Other examples of an output target are a file name on at least one storage 130 and a template value of a file name on at least one storage 130, where the template value comprises at least one variable file name element, for example a wildcard character in a file path or a file extension. An access instruction of a data pattern optionally defines allowance or forbiddance of one or more software programs running in virtualization container 111 outputting digital data to the at least one output target of the data pattern. Examples of an access instruction are: permission to listen to a network port, denial of permission to listen to a network port, permission to receive, denial of permission to receive, permission to send, and denial of permission to send. Optionally, host processor 101 retrieves the one or more software image files from at least one storage 130. Optionally, host processor 101 receives the one or more software image files via at least one data communication network adapter 120. Optionally, the plurality of data patterns comprises at least one data pattern defined according to Health Insurance Portability and Accountability Act of 1996 (HIPAA) security regulations. Optionally, the plurality of data patterns comprises at least one data pattern defined according to European Union (EU) General Data Protection Regulation (GDPR). Optionally, the plurality of data patterns comprises at least one data pattern defined by a policy of another regular authority or by an enterprise policy.

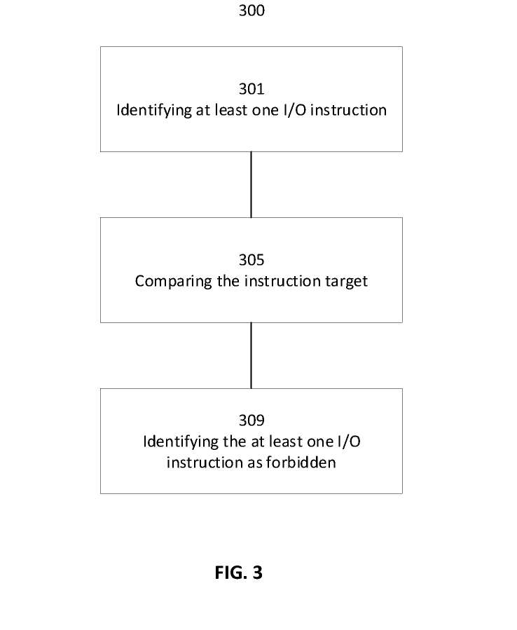

Optionally, while executing virtual container 111, host processor 101 optionally identifies in 211 at least one forbidden I/O instruction of virtual container 111 by matching an instruction target of at least one of a plurality of I/O instructions of the virtualization container with at least one output target of at least one data pattern of the plurality of data patterns. Reference is now made also to FIG. 3, showing a flow chart 300 schematically representing an optional flow of operations for identifying one or more forbidden input-output instructions, according to some embodiments of the present invention. In such embodiments, host processor 101 identifies in 301 at least one I/O instruction of the plurality of instructions of virtualization container 111 such that when host processor 101 executes the at least one I/O instruction host processor 101 receives or sends digital data via at least one data communication network interface 120. Optionally, host processor 101 identifies in 301 at least one I/O instruction of the plurality of instructions of virtualization container 111 such that when host processor 101 executes the at least one I/O instruction host processor 101 writes digital data to at least one storage 130. An instruction target of an I/O instruction may be a destination for writing digital data in an instruction to write digital data to a disk, or a network destination when sending digital data via a digital communication network interface. Optionally, in 305 host processor 101 compares the instruction target of the at least one I/O instruction identified in 301 to a plurality of output targets of the plurality of data patterns in order to identify at least one data pattern having at least one output target matching the instruction target according to a target matching test, and having an access instruction forbidding access to the at least one output target. An example of a target matching test is a comparison between a string value of the instruction target and a string value of the output target of the at least one data pattern. Subject to identifying the at least one data pattern in 305, in 309 host processor 101 optionally identifies the at least one I/O instruction identified in 301 as forbidden. Optionally, each data pattern of the plurality of data patterns has a priority. Optionally, host processor 101 applies the target matching test to some of the plurality of data patterns, in ascending or descending order of data pattern priority. Optionally, host processor 101 implements a policy resolution method as known in the industry to identify whether the at least one I/O output instruction is a forbidden output instruction according to the plurality of data patterns.

Reference is now made again to FIG. 2. After identifying at least one forbidden I/O instruction in 211 and while executing virtual container 111, in 215 host processor 101 optionally declines execution of the at least one forbidden I/O instruction identified in 211. By declining execution of the at least one forbidden I/O instruction, host processor 101 may enforce a security policy defined by the plurality of data patterns of the one or more software image files from which virtualization container 111 was created.

In some embodiments of the present invention, the security policy defined by the plurality of data patterns is enforced by modifying a plurality of computer instructions of at least one network system call of virtualization container 111. An example of a network system call is a system call invoked by a software program running in virtualization container 111 for the purpose of opening a network connection to an output target identified by a network address on a network port using a transport protocol. When virtualization container 111 executes such a network system call, one or more of a value of the network address, a value of a network port and a transport protocol identifier may be one or more of a plurality of parameters of the network system call. Optionally, host processor 101 modifies the plurality of computer instructions of the at least one network system call when creating virtualization container 111.

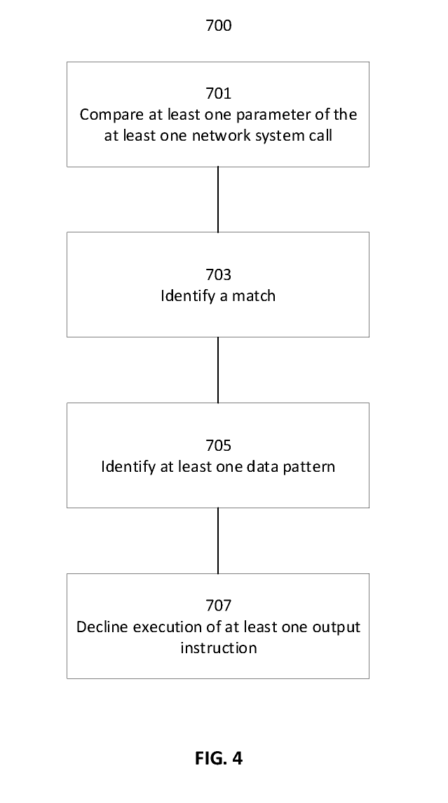

Reference is now made also to FIG. 4, showing a flow chart 700 schematically representing an optional flow of operations of a modified network system call, according to some embodiments of the present invention. In such embodiments, host processor 101 modifies the plurality of computer instructions of at least one network system call such that when host processor 101 executes the at least one network system call in 701 host processor 101 optionally compares at least one parameter of the at least one network system call to one or more output targets of the plurality of data patterns. In 703, when executing the at least one network system call, host processor 101 optionally identifies a match between the at least one parameter and at least one output target according to the target matching test. When executing the at least one network system call, host processor 101 optionally identifies in 705 at least one data pattern having the at least one output target and an access instruction forbidding access to the at least one output target and in 707 host processor 101 optionally declines execution of the at least one network system call, subject to identifying the at least one data pattern. Optionally, executing the modified at least one network system call inherently comprises identifying the at least one I/O instruction, thus executing the modified at least one network system call is an exemplary optional implementation of 301. An exemplary optional implementation of 305 comprises 701 and 705, and an exemplary optional implementation of 215 comprises 707.

Security-Enhanced Linux (SELinux) is a Linux kernel security module that provides a mechanism for supporting access control security policies. SELinux uses methods known in the art to enforce Mandatory Access Control (MAC) according to a policy; that is SELinux can use methods known in the art to constrain the ability of an initiator such as a software program to perform some sort of operation on a target, for example send digital data to the target. A SELinux policy comprises a plurality of rules that define permitted interactions amongst a plurality of computer system resources. A resource may be an initiator of an interaction, such as a process or a user. A resource may be a target of an interaction, for example an output target such as a network port number or a file name In a SELinux policy, each resource is assigned a label, identifying a security context of the resource. A security context of an initiator comprises a domain whereas a security context of a target comprises a type, grouping together like items based on their fundamental security sameness, i.e. targets having the same type are accessible in the same way by the same set of initiators. A rule defines how each domain may access each type. A label maps one or more resources to one or more rules. In some embodiments of the present invention, host operating system 102 implements SELinux. In such embodiments, the security policy defined by the plurality of data patterns may be enforced by configuring a SELinux policy of host operating system 102 according to the plurality of data patterns. In such embodiments, the security policy defined by the plurality of data patterns is enforced by SELinux enforcing the SELinux policy using methods as known in the art.

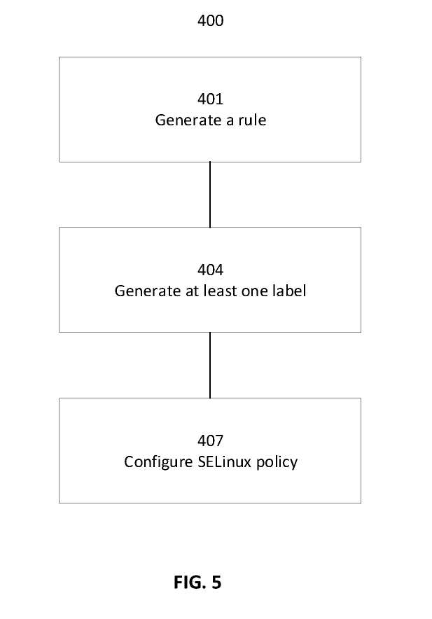

Reference is now made also to FIG. 5, showing a flow chart 400 schematically representing an optional flow of operations for configuring a SELinux based system, according to some embodiments of the present invention. In such embodiments, host operating system 102 implements SELinux and executing virtual container 111 comprises host processor 101 configuring the SELinux policy according to at least one data pattern of the plurality of data patterns. For each of the at least one data pattern, host processor 101 optionally generates in 401 a rule comprising the access instruction of the at least one data pattern and in 404 host processor 101 optionally generates at least one label mapping the at least one data pattern's at least one output target to the rule. For example, when a security policy forbids access to an identified network address, the output target of the at least one data pattern may be an identified network address and the access instruction of the at least one data pattern may be an instruction forbidding access. In this example, host processor 101 in 401 may generate an identified rule forbidding access and in 404 may generate an identified label mapping the identified network address to the identified rule, thus creating an SELinux policy directive that access to the identified address is forbidden. In 407, host processor 101 optionally configures the SELinux policy with the rule and the at least one label. Executing a SELinux method as known in the art to enforce MAC using the SELinux policy configured with the rule and the at least one label is an exemplary optional implementation of 301, 305 and 215.

In some embodiments of the present invention, in order to execute virtual container 111 by host processor 101 there is a need to produce the one or more software image files comprising the plurality of data patterns from which host processor 101 creates virtual container 111.

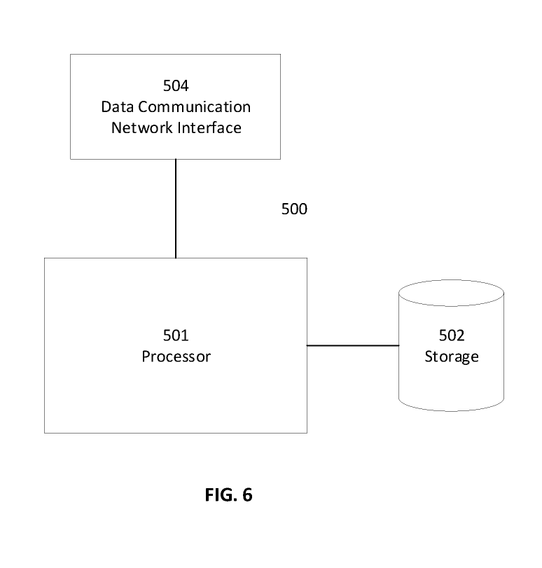

Reference is now made also to FIG. 6, showing a schematic block diagram of an exemplary system 500 for producing one or more software image files for creating a virtualization container, according to some embodiments of the present invention. In such embodiments, at least one hardware processor 500 is connected to at least one data communication network interface 504 and at least one storage 502. An example of storage is a hard disk. At least one data communication network interface 504 is optionally a Local Area Network interface such as an Ethernet network interface or a wireless network interface. Optionally at least one hardware processor 500 is connected to a wide area network, for example the Internet, via at least one data communication network interface 504.

To produce one or more software image files for creating a virtualization container, system 500 implements, in some embodiments, the following optional method.

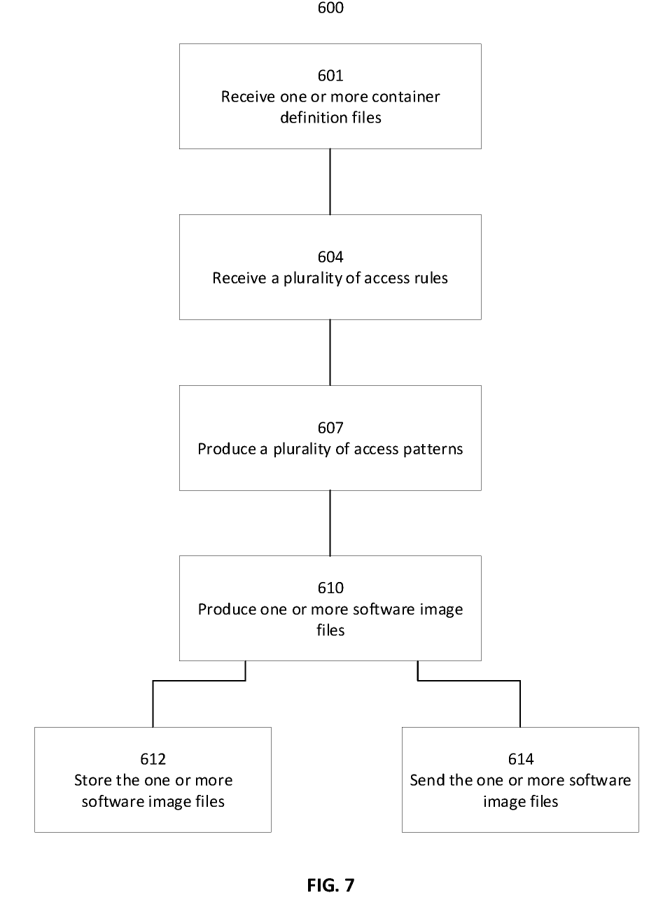

Reference is made now also to FIG. 7, showing a flow chart schematically representing an optional flow of operations 600 for producing a one or more software image files for creating a virtualization container, according to some embodiments of the present invention. In such embodiments, at least one hardware processor 501 receives in 601 one or more virtualization container definition files describing the virtual container. The virtualization container definitions files optionally comprise one or more values identifying one or more software programs to run in the virtual container. Optionally, the one or more virtualization container definition files comprise one or more Docker files, for example in an embodiment where the virtualization container is a Docker container. Optionally, the one or more virtualization container definition files reference one or more other virtualization container definition files, thus extending the one or more other virtualization container definition files.

In 604, at least one hardware processor 501 optionally receives a plurality of access rules governing input to and output from the virtualization container. Optionally, each access rule of the plurality of access rules comprises at least one first output target and a first access instruction. Examples of an output target are a value of a network address, a template value of a network address comprising at least one variable network address element, and a network port value. Other examples of an output target are a file name on a storage of a system executing the virtual container and a template value of a file name on a storage of a system executing the virtual container, where the template value comprises at least one variable file name element, for example a wildcard character in a file path or a file extension. Examples of an access instruction are: permission to listen to a network port, denial of permission to listen to a network port, permission to receive, denial of permission to receive, permission to send, and denial of permission to send. Optionally, the plurality of access rules comprises at least one access rule defined according to Health Insurance Portability and Accountability Act of 1996 (HIPAA) security regulations. Optionally, the plurality of access rules comprises at least one access rule defined according to European Union (EU) General Data Protection Regulation (GDPR). Optionally, at least one hardware processor 501 receives the plurality of access rules via at least one data communication network interface 504. Optionally, at least one hardware processor 501 retrieves the plurality of access rules from at least one storage 502.

In 607, at least one hardware processor 501 optionally produces a plurality of access patterns equivalent to the plurality of access rules, each comprising at least one second output target and a second access instruction. Optionally, the plurality of access patterns are in a digital format understood by a host operating system creating the virtual container, for example host operating system 102 executed by host processor 101. Optionally, each of the plurality of access patterns is a JavaScript Object Notation (JSON) object. Optionally, in 610 at least one host 501 produces one or more software image files comprising the plurality of access patterns and digital information for creating the virtualization container. For example, the digital information may comprise one or more software programs, one or more binary files such as one or more dependencies of the one or more software programs and one or more libraries used by the one or more software programs, and one or more configuration files needed to run the one or more software programs. Optionally, the digital information comprises one or more values identifying one or more libraries or dependencies of the one or more software programs. Optionally, the one or more software image files are Docker image files modified to comprise the plurality of access patterns, for example in an embodiment where the virtualization container is a Docker container. When the one or more virtualization container definition files reference one or more other virtualization container definition files, the one or more software image files optionally extend other one or more software image files created according to the one or more other virtualization container definition files.

In 612, at least one hardware processor 501 optionally stores the one or more software image files on at least one storage 502. In 614, at least one hardware processor 501 optionally sends the one or more software image files via at least one digital communication network interface 504, for example for the purpose of distributing the at least one or more software image files for installation on one or more other systems, or for the purpose of storing the one or more software image files on a repository from which the one or more other systems may retrieve the one or more software image files.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization container technologies will be developed and the scope of the term “virtualization container” is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for executing one or more operating-system-level virtualization software objects (virtualization containers), comprising:
at least one hardware processor connected to at least one data communication network interface, and adapted to:
for each of the one or more virtualization containers:
execute the virtualization container in at least one isolated process of an operating system, wherein the virtualization container is created from one or more software image files comprising a plurality of data patterns, each data pattern comprising at least one output target and an access instruction; and
while executing the virtualization container:
identify at least one forbidden input-output (I/O) instruction of the virtualization container, by matching an instruction target of at least one of a plurality of I/O instructions of the virtualization container with at least one output target of at least one data pattern of the plurality of data patterns; and
decline execution of the at least one forbidden I/O instruction.

2. The system of claim 1, wherein the at least one hardware processor is adapted to identify at least one forbidden I/O instruction by:
identifying at least one I/O instruction of the plurality of I/O instructions of the virtualization container, wherein executing the at least one I/O instruction results in the at least one hardware processor receiving or sending digital data via the at least one data communication network interface;
comparing the instruction target of the at least one I/O instruction to a plurality of output targets of the plurality of data patterns to identify at least one data pattern having at least one output target matching the instruction target according to a target matching test, and having an access instruction forbidding access to the at least one output target; and
identifying the at least one I/O instruction as forbidden subject to identifying the at least one data pattern.

3. The system of claim 1, wherein the at least one output target is a member of a group consisting of: a network address value, a network address template value comprising at least one variable network address element, and a network port value.

4. The system of claim 1, wherein at least one access instruction is a member of a group consisting of: permission to listen to a network port, denial of permission to listen to a network port, permission to receive, denial of permission to receive, permission to send, and denial of permission to send.

5. The system of claim 1, wherein the at least one hardware processor is adapted to execute the virtualization container by a container platform engine.

6. The system of claim 2, wherein when creating the virtualization container the at least one hardware processor is adapted to modify a plurality of computer instructions of at least one network system call of the virtualization container to:
compare at least one parameter of the at least one network system call to one or more output targets of the plurality of data patterns;
identify a match between the at least one parameter and at least one output target according to the target matching test;
identify at least one data pattern having the at least one output target and an access instruction forbidding access to the at least one output target; and
decline execution of at least one output instruction of the at least one network system call subject to identifying the at least one data pattern;
wherein executing the at least one modified network system call identifies the at least one I/O instruction of the virtualization container; and
wherein the at least one hardware processor is adapted to compare the instruction target of the at least one I/O instruction to a plurality of output targets of the plurality of data patterns, identify the at least one data pattern and decline execution of the at least one forbidden I/O instruction by executing the modified plurality of instructions of the at least one network system call.

7. The system of claim 2, wherein the at least one hardware processor is adapted to execute Security-Enhanced Linux (SELinux), wherein SELinux has a policy;
wherein executing the virtualization container comprises for at least one data pattern of the plurality of data patterns:
generating a rule comprising the access instruction of the at least one data pattern;
generating at least one label mapping the at least one output target of the at least one data pattern to the rule; and
configuring the SELinux policy with the rule and the at least one label; and
wherein the at least one hardware processor is adapted to identify the at least one I/O instruction of the virtualization container, comparing the instruction target of the at least one I/O instruction to a plurality of output targets of the plurality of data patterns, identify the at least one data pattern and decline execution of the at least one forbidden I/O instruction by executing a SELinux method as known in the art for enforcing Mandatory Access Control using the SELinux policy configured with the rule and the at least one label.

8. The system of claim 1, wherein the plurality of data patterns comprises at least one data pattern defined according to Health Insurance Portability and Accountability Act of 1996 (HIPAA) security regulations.

9. The system of claim 1, wherein the plurality of data patterns comprises at least one data pattern defined according to European Union (EU) General Data Protection Regulation (GDPR).

10. A method for executing one or more virtualization containers, comprising for each of the one or more virtualization containers:
executing the virtualization container in at least one isolated process of an operating system executed by at least one hardware processor, wherein the virtualization container is created from one or more software image files comprising a plurality of data patterns, each data pattern comprising at least one output target and an access instruction; and
while executing the virtualization container:
identify at least one forbidden input-output (I/O) instruction of the virtualization container, wherein the I/O instruction is forbidden according to the plurality of data patterns; and
decline execution of the forbidden at least one I/O instruction.

11. A computer implemented method for producing one or more software image files for creating a virtualization container, comprising:
receiving one or more virtualization container definition files describing the virtualization container;
receiving a plurality of access rules governing input to and output from the virtualization container, each comprising at least one first output target and a first access instruction;
producing a plurality of access patterns equivalent to the plurality of access rules, each comprising at least one second output target and a second access instruction; and
producing one or more software image files comprising the plurality of access patterns and digital information for creating the virtualization container.

12. The method of claim 11, wherein the plurality of access rules comprises at least one access rule defined according to Health Insurance Portability and Accountability Act of 1996 (HIPAA) security regulations.

13. The method of claim 11, wherein the plurality of access rules comprises at least one access rule defined according to European Union (EU) General Data Protection Regulation (GDPR).

14. The method of claim 11, wherein the one or more software image files are Docker image files modified to comprise the plurality of access patterns.

15. The method of claim 11, wherein the plurality of access rules are received via a data communication network interface connected to at least one hardware processor executing the method or by reading the plurality of data patterns from a digital storage connected to the at least one hardware processor.

16. The method of claim 11, further comprising storing the one or more software image files on a digital storage connected to at least one hardware processor executing the method.

17. The method of claim 11, further comprising sending the one or more software image files via a digital communication network interface connected to at least one hardware processor executing the method.
